(19) United States
(12) Patent Application Publication
(10) Pub. No.: US 2004/0133009 A1
(43) Pub. Date: Jul. 8, 2004

(54) Transition metal compound provided as a catalyst constituent, and use thereof for producing polyolefins

(76) Inventors: Jorg Schottek, Frankfurt (DE); Jorg Schulte, Frankfurt (DE); Cornelia Fritze, Frankfurt (DE)

Correspondence Address: James P Zeller, Marshall Gerstein & Borun, 6300 Sears Tower, 233 South Wacker Drive, Chicago, IL, 60606-6357, US

(21) Appl. No.: 10/468,271

(22) PCT Filed: Feb. 15, 2002
(86) PCT No.: PCT/EP02/01602

(30) Foreign Application Priority Data
Feb. 17, 2001 (DE) 101 07 525.1

(51) Int. Cl. C07F 15/00

(52) U.S. Cl. 548/101

(57) ABSTRACT

Transition metal compound as catalyst constituent for the polymerisation olefins, their production and use for the production of polyolefins

The present invention relates to transition metal compounds (non-metallocenes) containing oxazoline groups in the ligand system, as catalyst constituent for the polymerisation of olefins and processes for their production and use in the polymerisation of olefins.

The present invention relates to transition metal compounds (non-metallocenes) containing oxazoline groups in the ligand system, as catalyst constituent for the polymerisation of olefins and processes for their production and use in the polymerisation of olefins.

In the last few years, metallocenes, in, particular, have been used—apart from Ziegler-Natta catalysts—for the polymerisation of olefin in order to produce polyolefins with new property profiles. Metallocenes can be used in combination with one or several co-catalysts as catalyst constituent for the polymerisation and copolymerisation of olefins. However, the synthesis, which is frequently multiple stage, and use of metallocenes still presents a considerable cost factor nowadays.

The so-called non-metallocene complexes and their use in olefin polymerisation are well known. In WO 96/23010, transition metal complexes containing diimine groups as ligands, their production and their use in olefin polymerisation are described.

From WO 00/69923, individual organometal complexes are known; however, they are not the subject matter of the present invention.

In EP-A0942010, further transition metal complexes containing oxazoline derivates as ligands and their use in the polymerisation of olefins are described.

The non-metallocene complexes described in the literature are not always characterised by a superior polymerisation activity and, in particular, it has not yet been possible to produce isotactic polypropylenes of sufficient tacticity.

Consequently, the task existed of synthesising new transition metal complexes which can be produced simply and cost-effectively and which exhibit a strong polymerisation activity and stereo as well as regio selectivity in the polymerisation of olefins.

Surprisingly enough, it has been found that, starting out from substituted or unsubstituted oxazoline derivatives, ligand structures can be constructed which, by reaction with a transition metal compound, are capable of reacting to form a transition metal complex which is suitable for the polymerisation of olefins.

The subject matter of the present invention consists of the use of compounds of formula (I)

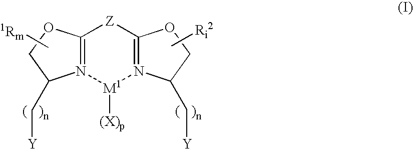

in which

M¹ is a metal from the group of the elements Ti, Zr, Hf, Ni, V, W, Mn, Rh, Ir, Cu, Co, Fe, Pd, Sc, Cr and Nb

R¹, R² respectively, are the same or different, represent a hydrogen atom or

Si(R¹²)₃, R¹² representing in the same way or differently a hydrogen atom or a C₁-C₄₀ carbon-containing group, in particular C₁-C₂₀ alkyl, C₁-C₁₀ fluoroalkyl, C₁-C₁₀ alkoxy, C₆-C₂₀ aryl, C₆-C₁₀ fluoroaryl, C₆-C₁₀ aryloxy, C₂-C₁₀ alkenyl, C₇-C₄₀ arylalkyl, C₇-C₄₀ alkylaryl or C₈-C₄₀ arylalkenyl,

or R¹, R², respectively, are the same or different, represent a C₁-C₃₀ carbon-containing group, in particular C₁-C₂₅ alkyl, particularly preferably methyl, ethyl, n-propyl, i-propyl, tert.-butyl, n-hexyl, cyclohexyl or octyl, C₂-C₂₅ alkenyl, C₃-C₁₅ alkylalkenyl, C₆-C₂₄ aryl, C₅-C₂₄ heteroaryl, C₇-C₃₀ arylalkyl, C₇-C₃₀ alkylaryl, fluorine-containing C₁-C₂₅ alkyl, fluorine-containing C₆-C₂₄ aryl, fluorine-containing C₇-C₃₀ arylalkyl, fluorine-containing C₇-C₃₀ alkylaryl or C₁-C₁₂ alkoxy,

or the radicals R¹ and R² can be linked with each other such that the radicals R¹ and R² respectively are bound to the oxazole ring such that the radicals, R¹ and/or R² and the atoms linking them with the oxazole ring respectively form a C₄-C₂₄ ring system which in turn may be substituted,

n are the same or different and represent an integer between 1 and 3 and, if n represents the figure 0, at least one R¹, R² radical is not the same as hydrogen,

m is equal 0, 1, 2, 3 or 4,

i is equal 0, 1, 2, 3 or 4,

X can be the same or different and represent a hydrogen atom, a C₁-C₁₀ carbon-containing group, in particular C₁-C₁₀ alkyl or C₆-C₁₀ aryl, a halogen atom or OR⁹, SR⁹, OSi(R⁹)₃, Si(R⁹)₃, P(R⁹)₂ or N(R⁹)₂, in which R⁹ are a halogen atom, a C₁-C₁₀ alkyl group, a halogenated C₁-C₁₀ alkyl group, a C₆-C₂₀ aryl group or a halogenated C₆-C₂₀ aryl group or the X radical or radicals are a toluene sulphonyl group, a trifluoroacetyl, trifluoroacetoxyl, trifluoromethane sulphonyl, nonafluorobutane sulphonyl or 2,2,2-trifluoroethane sulphonyl group.

Y is equal OR¹⁰, SR¹⁰, OSi(R¹⁰)₃, Si(R¹⁰)₃, P(R¹⁰)₂ or N(R¹⁰)₂ in which the individual R¹⁰ may in the same way or differently represent a hydrogen atom, a halogen atom, a C₁-C₁₀ alkyl group, a halogenated C₁-C₁₀ alkyl group, a C₆-C₂₀ aryl group or a halogenated C₆-C₂₀ aryl group and Y may form a cyclic system with one or several R¹ and/or R² radicals,

p may be equal 1, 2, 3 or 4 and,

Z is a bridging structural element of formula M²R¹³R¹⁴, in which M² represents carbon, nitrogen, phosphorus, oxygen, sulphur, silicon, germanium, boron, aluminium or tin and R¹³ and R¹⁴ may be the same or different and represent a hydrogen atom, a C₁-C₂₄ hydrocarbon-containing group, in particular C₁-C₁₀ alkyl, particularly preferably methyl, ethyl, n-propyl-, i-propyl-, tert-butyl, n-hexyl, cyclohexyl or octyl, C₂-C₁₀ alkenyl, C₃-C₁₀ alkylalkenyl, C₆-C₂₄ aryl, C₅-C₂₄ heteroaryl, C₇-C₂₄ arylalkyl, C₇-C₂₄ alkylaryl, fluorine-containing C₁-C₂₄ alkyl, fluorine-containing C₆-C₂₄ aryl, fluorine-containing C₇-C₂₄ arylalkyl, fluorine-containing C₇-C₂₄ alkylaryl or C₁-C₁₂ alkoxy or trimethylsilyl, in which the R¹³ and R¹⁴ radicals may be linked with each other in such a way that the R¹³ and R¹⁴ radicals form a C₄-C₂₄ ring system with the atoms linking them, which ring system in turn may be substituted, between the two oxazole rings, with the exception of the compounds [2,6-bis-(4S-isopropyl-2-oxaziln-2-yl)pyridine]MnCl2; [2,6-bis-(4S-isopropyl-2-oxaziln-2-yl)pyridine]CrCl2; [2,6-bis-(4S-isopropyl-2-oxaziln-2-yl)pyridine]FeCl2; [2,6-bis-(4S-isopropyl-2-oxaziln-2-yl)pyridine]FeCl3; [2,6-bis-(4S-isopropyl-2-oxaziln-2-yl)pyridine]VCl3; [2,6-bis-(4S-isopropyl-2-oxaziln-2-yl)pyridine]TiCl3 and [2,6-bis-(4S-isopropyl-2-oxaziln-2-yl)pyridine]ScCl3, for the polymerisation of olefins.

Preferably, Z is equal Z CH₂, CH₂CH₂, CH(CH₃)CH₂, C(C₆H₅)₂, (C₆H₄)₂, (C₁₂H₈)₂, (C₂₀H₁₂)₂, NH, N—CH₃, N—(C₆H₅), N—C₃H₇, CH(C₄H₉)C(CH₃)₂, C(CH₃)₂, (CH₃)₂Si, (CH₃)₂Ge, (CH₃)₂Sn, (C₆H₅)₂Si, (C₆H₅)(CH₃)Si, (C₆H₅)₂Ge, (C₆H₅)₂Sn, (CH₂)₄Si, CH₂Si(CH₃)₂, o-C₆H₄, 2,6 bispyridines or 2,2′-(C₆H₄)₂ as well as 1,2-(methyl ethanediyl), 1,2-(1,1-dimethyl ethanediyl) and 1,2-(1,2-dimethyl ethanediyl).

The term C₁-C₄₀ carbon-containing group should be understood within the framework of the present invention to mean in particular the radicals C₁-C₂₀ alkyl, in particular methyl, ethyl, n-propyl-, i-propyl-, tert.-butyl, n-hexyl, cyclohexyl or octyl, C₁-C₁₀-fluoroalkyl, C₁-C₁₀ alkoxy, C₆-C₂₀ aryl, C₆-C₁₀ fluoroaryl, C₆-C₁₀ aryloxy, C₂-C₁₀ alkenyl, C₇-C₄₀ arylalkyl, C₇-C₄₀ alkylaryl or C₈-C₄₀ arylalkenyl.

The term C₁-C₃₀ carbon-containing group should be understood to mean in the context of the present invention in particular the radicals C₁-C₂₅ alkyl, in particular methyl, ethyl, n-propyl-, i-propyl-, tert.-butyl, n-hexyl, cyclohexyl or octyl, C₂-C₂₅ alkenyl, C₃-C₁₅ alkylalkenyl, C₆-C₂₄ aryl, C₅-C₂₄ heteroaryl, C₇-C₃₀ arylalkyl, C₇-C₃₀ alkylaryl, fluorine-containing C₁-C₂₅ alkyl, fluorine-containing C₆-C₂₄ aryl, fluorine-containing C₇-C₃₀ arylalkyl, fluorine-containing C₇-C₃₀ alkylaryl or C₁-C₁₂ alkoxy.

The term C₁-C₂₄ hydrocarbon-containing group should be understood to mean in the context of the present invention in particular the radicals C₁-C₁₀ alkyl, in particular methyl, ethyl, n-propyl-, i-propyl-, tert.-butyl, n-hexyl, cyclohexyl or octyl, C₂-C₁₀ alkenyl, C₃-C₁₀ alkylalkenyl, C₆-C₂₄ aryl, C₅-C₂₄ heteroaryl, C₇-C₂₄ arylalkyl, C₇-C₂₄ alkylaryl, fluorine-containing C₁-C₂₄ alkyl, fluorine-containing C₆-C₂₄ aryl, fluorine-containing C₇-C₂₄ arylalkyl, fluorine-containing C₇-C₂₄ alkylaryl or C₁-C₁₂ alkoxy.

The compounds of formula (II) are particularly preferred

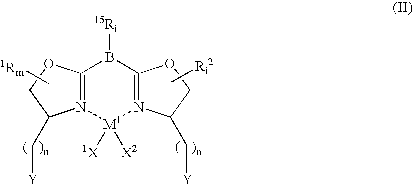

in which

M¹ is equal Ni, Pd, Co, Fe, Ti, Zr or Hf,

R¹, R² respectively, are the same or different, represent a hydrogen atom or

Si(R¹²)₃, R¹² representing in the same way or differently a hydrogen atom or a C₁-C₄₀ carbon-containing group, in particular C₁-C₂₀ alkyl, C₁-C₁₀ fluoroalkyl, C₁-C₁₀ alkoxy, C₆-C₂₀ aryl, C₆-C₁₀ fluoroaryl, C₆-C₁₀ aryloxy, C₂-C₁₀ alkenyl, C₇-C₄₀ arylalkyl, C₇-C₄₀ alkylaryl or C₈-C₄₀ arylalkenyl,

or R¹, R², respectively, are the same or different, represent a C₁-C₃₀ carbon-containing group, in particular C₁-C₂₅ alkyl, particularly preferably methyl, ethyl, n-propyl, i-propyl, tert.-butyl, n-hexyl, cyclohexyl or octyl, C₂-C₂₅ alkenyl, C₃-C₁₅ alkylalkenyl, C₆-C₂₄ aryl, C₅-C₂₄ heteroaryl, C₇-C₃₀ arylalkyl, C₇-C₃₀ alkylaryl, fluorine-containing C₁-C₂₅ alkyl, fluorine-containing C₆-C₂₄ aryl, fluorine-containing C₇-C₃₀ arylalkyl, fluorine-containing C₇-C₃₀ alkylaryl or C₁-C₁₂ alkoxy,

or the radicals R¹ and R² can be linked with each other such that the radicals R¹ and/or R² and the atoms linking them with the oxazole ring respectively form a C₄-C₂₄ ring system which in turn may be substituted,

n are the same or different and represent an integer between 1 and 3 and, if n represents the figure 0, at least one R¹, R² radical is not the same as hydrogen,

m is equal 0, 1, 2, 3 or 4,

i is equal 0, 1, 2, 3 or 4,

X¹, X² can be the same or different and represent a hydrogen atom, a C₁-C₁₀ carbon-containing group, in particular C₁-C₁₀ alkyl or C₆-C₁₀ aryl, a halogen atom or OR⁹, SR⁹, OSi(R⁹)₃, Si(R⁹)₃, P(R⁹)₂ or N(R⁹)₂, in which R⁹ are a halogen atom, a C₁-C₁₀ alkyl group, a halogenated C₁-C₁₀ alkyl group, a C₆-C₂₀ aryl group or a halogenated C₆-C₂₀ aryl group or the radicals X1, X2 are a toluene sulphonyl group, a trifluoroacetyl, trifluoroacetoxyl, trifluoromethane sulphonyl, nonafluorobutane sulphonyl or 2,2,2-trifluoroethane sulphonyl group.

R¹⁵ may in the same way or differently represent a hydrogen atom, a C₁-C₂₄ hydrocarbon-containing group, in particular C₁-C₁₀ alkyl, particularly preferably methyl, ethyl, n-propyl-, i-propyl-, tert.-butyl, n-hexyl, cyclohexyl or octyl, C₂-C₁₀ alkenyl, C₃-C₁₀ alkylalkenyl, C₆-C₂₄ aryl, C₅-C₂₄ heteroaryl, C₇-C₂₄ arylalkyl, C₇-C₂₄ alkylaryl, fluorine-containing C₁-C₂₄ alkyl, fluorine-containing C₆-C₂₄ aryl, fluorine-containing C₇-C₂₄ arylalkyl, fluorine-containing C₇-C₂₄ alkylaryl or C₁-C₁₂ alkoxy or trimethylsilyl or several R¹⁵ radicals can be linked to each other such that they form a C₄-C₂₄ ring system which in turn may be substituted,

B corresponds to the radicals described for radical Z in formula (I),

Y is equal OR¹⁰, SR¹⁰, OSi(R¹⁰)₃, Si(R¹⁰)₃, P(R¹⁰)₂ or N(R¹⁰)₂ in which the individual R¹⁰ may in the same way or differently represent a hydrogen atom, a halogen atom, a C₁-C₁₀ alkyl group, a halogenated C₁-C₁₀ alkyl group, a C₆-C₂₀ aryl group or a halogenated C₆-C₂₀ aryl group and Y may form a cyclic system with one or several R¹ and/or R² radicals.

Explanatory though non-limiting examples of the compounds of formula (I) and (II) according to the invention are:

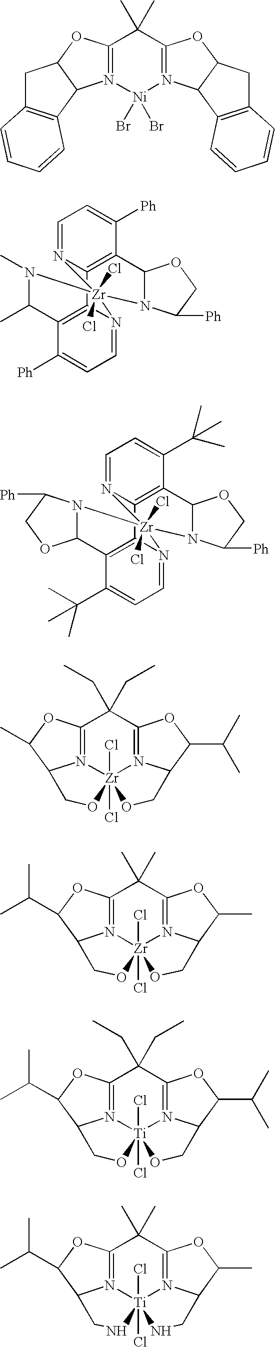

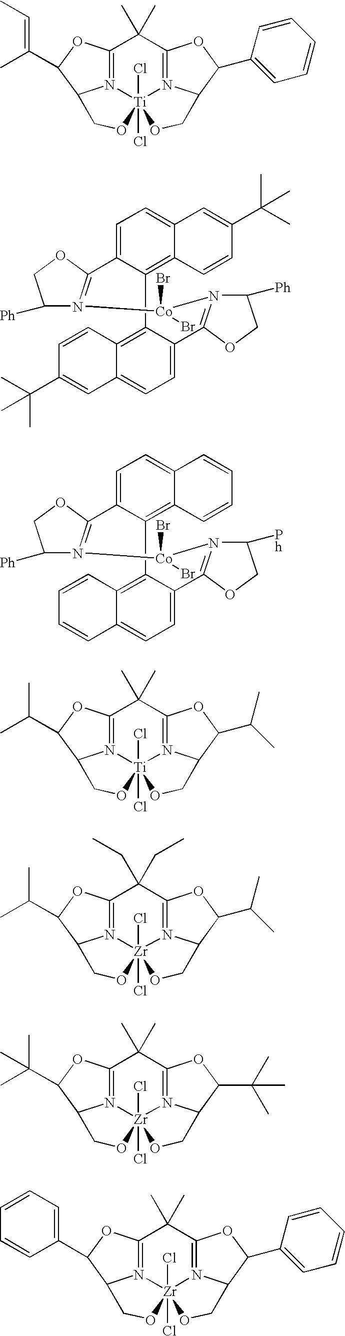

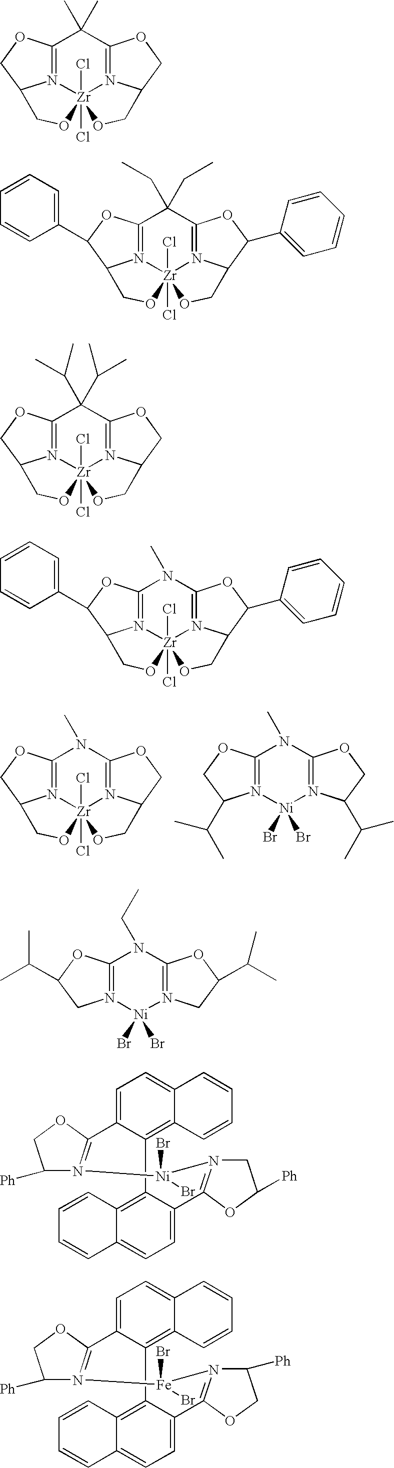

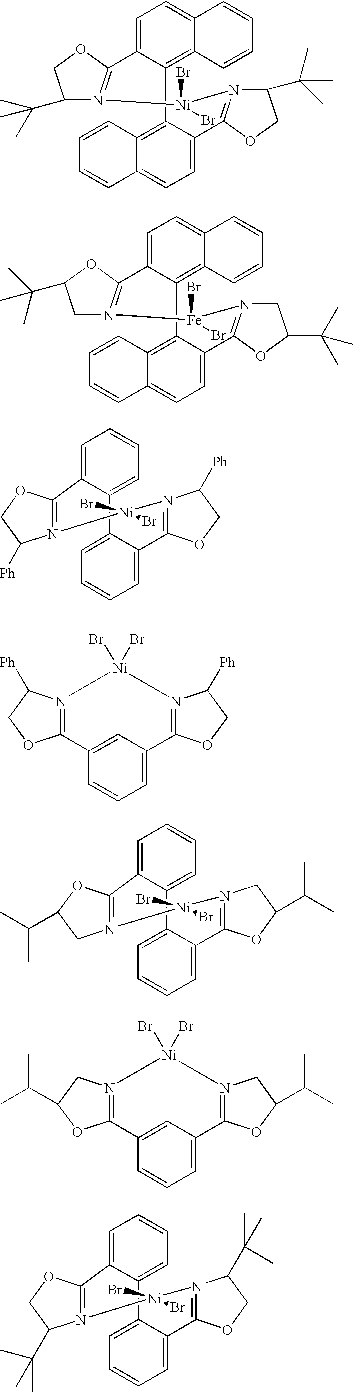

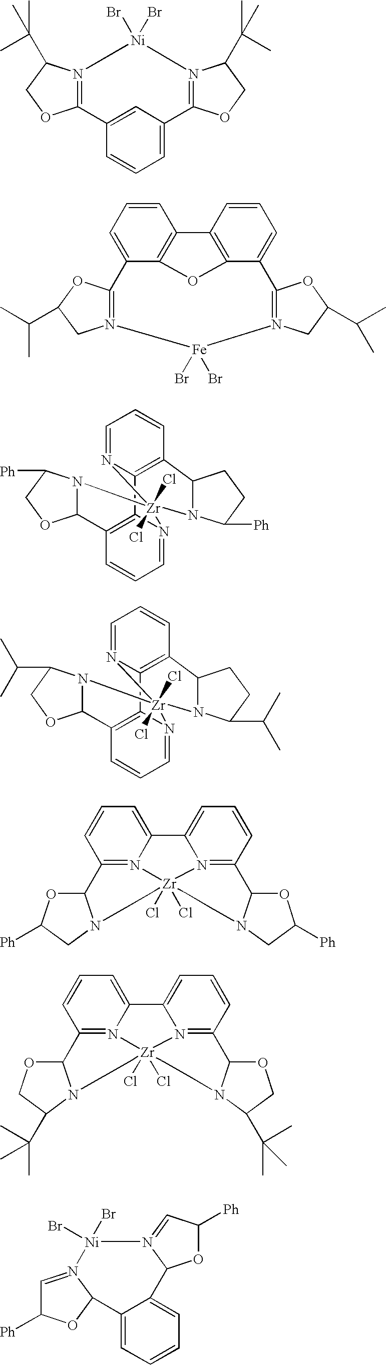

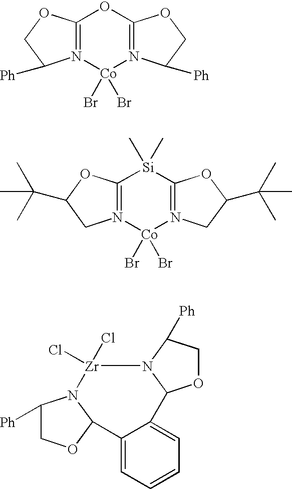

A further subject matter of the present invention consists of catalyst systems for the production of polyolefins by the polymerisation of at least one olefin in the presence of at least one compound of formula (I). These catalyst systems contain at least one co-catalyst, apart from at least one compound of formula (I).

The co-catalyst which forms the catalyst system together with a transition metal compound of formula I contains at least one compound of the type of an aluminoxane or a Lewis acid or an ionic compound which, by reaction with the transition metal compound, converts it into a cationic compound.

A compound with the general formula IX

(R AlO)ₙ Formula IX

is preferably used as aluminoxane.

Other suitable aluminoxanes may, for example, be cyclic as in formula X

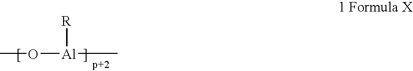

or linear as in formula XI

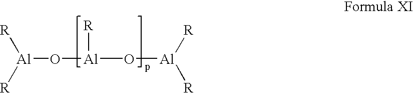

or of the cluster type as in formula XII

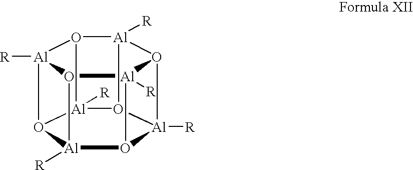

Such aluminoxanes are described in JACS 117 (1995), 6465-74, Organometallics 13 (1994), 2957-2969, for example.

The R radicals in formulae IX, X, XI and XII may be the same or different and represent a C₁-C₂₀ hydrocarbon group such as a C₁-C₆ alkyl group, a C₆-C₁₈ aryl group, benzyl or hydrogen and p may represent an integer of 2 to 50, preferably 10 to 35.

Preferably, the R radicals are the same and represent methyl, isobutyl, n- butyl, phenyl or benzyl, particularly preferably methyl.

If the R radicals differ from each other, they are preferably methyl and hydrogen, methyl and isobutyl or methyl and n-butyl, hydrogen and/or isobutyl or n-butyl being preferably present in an amount of 0.01-40% (number of R radicals).

The aluminoxane may be produced in different ways according to known processes. One of the methods involves, for example, reacting an aluminium hydrocarbon compound and/or a hydridoaluminium hydrocarbon compound with water (gaseous, solid, liquid or combined—for example as water of crystallisation) in an inert solvent (such as e.g. toluene).

For the production of an aluminoxane with different R alkyl groups, two different aluminium trialkyls (AlR₃+AlR′₃), depending on the desired composition and reactivity, are reacted with water (compare S. Pasynkiewicz, Polyhedron 9 (1990) 429 and EP-A-0 302 424).

Irrespective of the type of production, all aluminoxane solutions have the common feature of a changing content of unreacted aluminium starting compound which is present in the free form or as an adduct.

Preferably, at least one organoboron or organoaluminium compound is used as Lewis acid, which contain C₁-C₂₀ carbon-containing groups such as branched or unbranched alkyl or halogen alkyl, such as e.g. methyl, propyl, isopropyl, isobutyl, trifluoromethyl, unsaturated groups such as aryl or halogen aryl such as phenyl, toluyl, benzyl groups, p-fluorophenyl, 3,5-difluorophenyl, pentachlorophenyl, pentafluorophenyl, 3,4,5 trifluorophenyl and 3,5 di(trifluoromethyl)phenyl.

Examples of Lewis acids are trimethylaluminium, triethylaluminium, triisobutylaluminium, tributylaluminium, trifluoroborane, triphenylborane, tris(4-fluorophenyl)borane, tris(3,5-difluorophenyl)borane, tris(4-fluoromethylphenyl)borane, tris(pentafluorophenyl)borane, tris(tolyl)borane, tris(3,5-dimethylphenyl)borane, tris(3,5-difluorophenyl)borane and/or tris(3,4,5-trifluorophenyl)borane. Tris(pentafluorophenyl)borane is particularly preferred.

Preferably, compounds are used as ionic co-catalysts which contain a non-co-ordinated anion such as, for example, tetrakis(pentafluorophenyl)borates-tetraphenylborates, SbF₆—, CF₃SO₃— or ClO₄—. Protonated Lewis bases are used as cationic counter-ions such as e.g. methylamine, aniline, N,N-dimethylbenzylamine and derivatives, N,N-dimethylcyclohexylamine and their derivatives, dimethylamine, diethylamine, N-methylaniline, diphenylamine, N,N-dimethylaniline, trimethylamine, triethylamine, tri-n-butylamine, methyldiphenylamine, pyridine, p-bromo-N,N-dimethylaniline, p-nitro-N,N-dimethylaniline, triethylphosphine, triphenylphosphine, diphenylphosphine, tetrahydrothiophene or triphenylcarbenium.

Examples of such ionic compounds are

triethylammonium tetra(phenyl)borate,

tributylammonium tetra(phenyl)borate,

trimethylammonium tetra(tolyl)borate,

tributylammonium tetra(tolyl)borate,

tributylammonium tetra(pentafluorophenyl)borate,

tributylammonium tetra(pentafluorophenyl)aluminate,

tripropylammonium tetra(dimethylphenyl)borate,

tributylammonium tetra(trifluoromethylphenyl)borate,

tributylammonium tetra(4-fluorophenyl)borate,

N,N-dimethylanilinium tetra(phenyl)borate,

N,N-diethylanilinium tetra(phenyl)borate,

N,N-dimethylanilinium tetrakis(pentafluorophenyl)borate,

N,N-dimethylanilinium tetrakis(pentafluorophenyl)aluminate,

N,N-dimethylcyclohexylammonium tetrakis(pentafluorophenyl)borate,

N,N-dimethylbenzylammonium tetrakis(pentafluorophenyl)borate,

di(propyl)ammonium tetrakis(pentafluorophenyl)borate,

di(cyclohexyl)ammonium tetrakis(pentafluorophenyl)borate,

triphenylphosphonium tetrakis(phenyl)borate,

triethylphosphonium tetrakis(phenyl)borate,

diphenylphosphonium tetrakis(phenyl)borate,

tri(methylphenyl)phosphonium tetrakis(phenyl)borate,

tri(dimethylphenyl)phosphonium tetrakis(phenyl)borate,

triphenylcarbenium tetrakis(pentafluorophenyl)borate,

triphenylcarbenium tetrakis(pentafluorophenyl)aluminate,

triphenylcarbenium tetrakis(phenyl)aluminate,

ferrocenium tetrakis(pentafluorophenyl)borate and/or

ferrocenium tetrakis(pentafluorophenyl)aluminate.

Triphenylcarbenium tetrakis(pentafluorophenyl)borate and/or N,N-dimethylanilinium tetrakis(pentafluorophenyl)borate are preferred. Mixtures of at least one Lewis acid and at least one ionic compound may also be used.

Borane or carborane compounds such as e.g. 7,8-dicarbaundecaborane(13), undecahydride-7,8-dimethyl-7,8-dicarbaundecaborane, dodecahydride-1-phenyl-1,3-dicarbanonaborane, tri(butyl)ammonium undecahydride-8-ethyl-7,9-dicarbaundecaborate, 4-carbanonaborane(14)bis(tri(butyl)ammonium)nonaborate, bis(tri(butyl)ammonium) undecaborate, bis(tri(butyl)ammonium) dodecaborate, bis(tri(butyl)ammonium) decachlorodecaborate, tri(butyl)ammonium-1-carbadecaborate, tri(butyl)ammonium-1-carbadodecaborate, tri(butyl)ammonium-1-trimethylsilyl-1-carbadecaborate, tri(butyl)ammoniumbis(nonahydride-1,3-dicarbonnonaborate) cobaltate(iii), tri(butyl)ammoniumbis(undecahydride-7,8-dicarbaundecaborate) ferrate(III) are also important as co-catalyst components.

Combinations of at least one of the above-mentioned amines and, optionally, a carrier with organoelement compounds, as described in the patent WO 99/40129, are also important as co-catalysts systems. The carriers with organoelement compounds mentioned in WO 99/40129 form also part of the present invention.

A preferred constituent of these co-catalyst systems consists of the compounds of formulae (A) and (B),

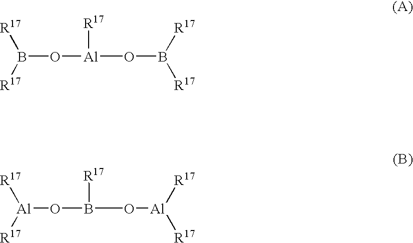

in which

R¹⁷ represents a hydrogen atom, a halogen atom, a C₁-C₄₀ carbon-containing group, in particular C₁-C₂₀ alkyl, C₁-C₂₀ halogen alkyl, C₁-C₁₀ alkoxy, C₆-C₂₀ aryl, C₆-C₂₀ halogen aryl, C₆-C₂₀ aryloxy, C₇-C₄₀ arylalkyl, C₇-C₄₀ halogen arylalkyl, C₇-C₄₀ alkylaryl or C₇-C₄₀ halogen alkylaryl. R¹⁷ may also be an —OSiR¹⁸₃ group in which R are the same or different and have the same meaning as R¹⁷.

In addition, those compounds should be regarded as a further preferred co-catalyst in general which are formed by the reaction of at least on compound of formula (C) and/or (D) and/or (E) with at least one compound of formula (F).

R_{f}¹⁷B-(DR¹⁶)_{g} (C)

R₂¹⁷B—X⁴—BR₂¹⁷ (D)

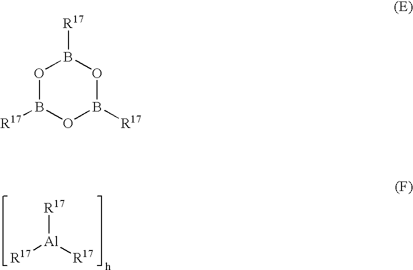

in which

R¹⁶ may be a hydrogen atom or a boron-free C₁-C₄₀ carbon-containing group such as C₁-C₂₀ alkyl, C₆-C₂₀ aryl, C₇-C₄₀ arylalky, C₇-C₄₀ alkylaryl and in which

R¹⁷ has the same meaning as mentioned above,

X⁴ is equal to an element of the main group VI of the periodic system of elements or an NR group in which R is a hydrogen atom or a C₁-C₂₀ hydrocarbon radical such as C₁-C₂₀ alkyl or C₁-C₂₀ aryl,

D is equal to an element of the main group VI of the periodic system of elements or an NR group in which R is a hydrogen atom or a C₁-C₂₀ hydrocarbon radical such as C₁-C₂₀ alkyl or C₁-C₂₀ aryl,

f is an integer of 0 to 3

g is an integer of 0 to 3, z+y not being equal 0

h is an integer of 1 to 10.

If necessary, the organoelement compounds are combined with an organometal compound of formula IX to XII and/or XIII [M⁵R¹⁹_{q}]ₖ in which M⁵ is an element of the main groups I, II and III of the periodic system of elements, R¹⁹ is the same or different and represents a hydrogen atom, a halogen atom, a C₁-C₄₀ carbon-containing group, in particular C₁-C₂₀ alkyl-, C₆-C₄₀ aryl-, C₇-C₄₀ arylalkyl or C₇-C₄₀ alkylaryl group, q is an integer of 1 to 3 and k is an integer of 1 to 4.

Examples of compounds of formula A and B with a co-catalytic effect are

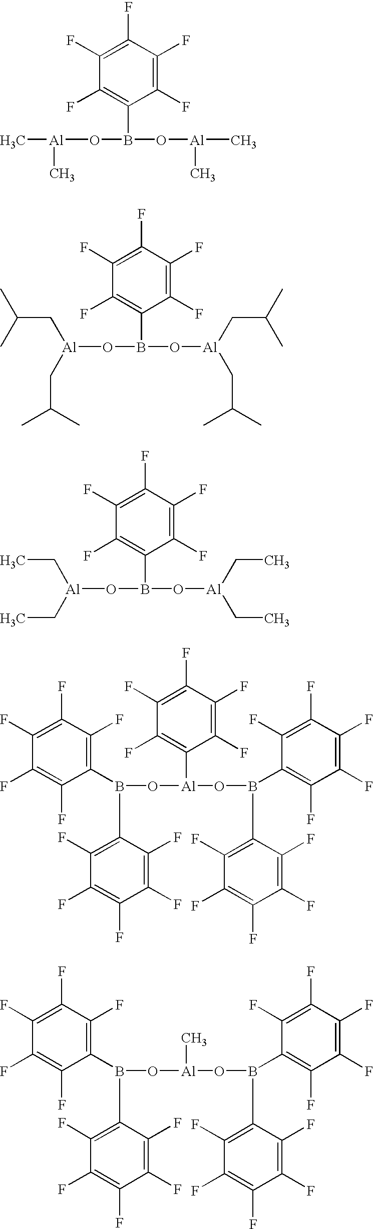

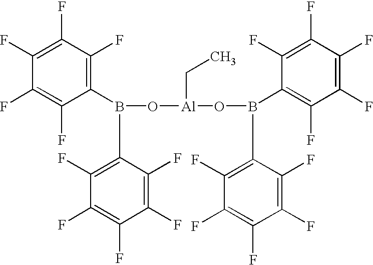

The organometal compounds of formula XIII are preferably neutral Lewis acids in which M⁵ represents lithium, magnesium and/or aluminium, in particular aluminlium. Examples of the preferred organometal compounds of formula IX are trimethylaluminium, triethylaluminium, triisopropylaluminium, trihexylaluminium, trioctylaluminium, tri-n-butylaluminium, tri-n-propylaluminium, triisoprenealuminium, dimethylaluminium monochloride, diethylaluminium monochloride, diisobutylaluminium monochloride, methylaluminium sesquichloride, ethylaluminium sesquichloride, dimethylaluminium hydride, diethylaluminium hydride, diisopropylaluminium hydride, dimethylaluminium (trimethylsiloxide), dimethylaluminium (triethylsiloxide), phenyl alane, pentafluorophenyl alane and o-tolyl alane.

The compounds mentioned in EP-A-924223, DE-A-19622207, EP-A-601830, EP-A-824112, EP-A-824113, EP-A-811627, WO97/11775 and DE-A-19606167 may be used as further co-catalysts which may be non-carrier-supported or carrier-supported.

The carrier component of the catalyst system may be any desired organic or inorganic, inert solid, in particular a porous carrier such as talcum, inorganic oxides and finely divided polymer powder (e.g.. polyolefins).

Suitable inorganic oxides may be found in groups 2, 3, 4, 5, 13, 14, 15 and 16 of the periodic system of elements. Examples of oxides which are preferred as carrier include silicon dioxide, aluminium oxide and mixed oxides of the elements calcium, aluminium, silicon, magnesium, titanium and the corresponding oxide mixtures as well as hydrotalcites. Other inorganic oxides which may be used alone or in combination with the preferred oxide carriers last mentioned are e.g. MgO, ZrO₂, TiO₂ or B₂O₃, to mention just a few.

The carrier materials used have a specific surface area in the region of 10 to 1000 m²/g, a pore volume in the region of 0.1 to 5 ml/g and an average particle size of 1 to 500 μm. Carriers with a specific surface area in the region of 50 to 500 μm, a pore volume in the region of between 0.5 and 3.5 ml/g and an average particle size in the region of 5 to 350 μm are preferred. Carriers with a specific surface area in the region of 200 to 400 m²/g, a pore-volume in the region of between 0.8 and 3.0 ml/g and an average particle size of 10 to 200 μm are particularly preferred.

If the carrier material used has an inherently low moisture content or residual solvent content, dehydration or drying may be omitted before use. If this is not the case, e.g. when using silica gel as carrier material, dehydration or drying is recommended. Thermal dehydration or drying of the carrier material may take place under vacuum -with simultaneous blanketing-with inert gas (e.g. nitrogen). The drying temperature is in region between 100 and 1000° C., preferably between 200 and 800° C. The pressure parameter is not of decisive importance in this case. The duration of the drying process may be between 1 and 24 hours. Shorter or longer drying periods are possible provided that the equilibrium adjustment with the hydroxyl groups on the carrier surface may take place under the conditions chosen; normally, this requires 4 to 8 hours.

Dehydration or drying of the carrier material is also possible by the chemical route by causing the adsorbed water and the hydroxyl groups on the surface to react with suitable inertisation agents. By reaction with the inertisation reagent, the hydroxyl groups may be converted completely or partially into a form which does not lead to a negative interaction with the catalytically active centres. Suitable inertisation agents are, for example, silicon halides and silanes, such as silicon tetrachloride, chlorotrimethylsilane, dimethylaminotrichlorosilane or organometal compounds of aluminium, boron and magnesium such as, for example, trimethylaluminium, triethylaluminium, triisobutylaluminium, triethylborane, dibutylmagnesium. As an example, the chemical dehydration or inertisation of the carrier material takes place by causing a suspension of the carrier material in a suitable solvent to react, with the exclusion of air and moisture, with the inertisation reagent in the pure form or dissolved in a suitable solvent. Suitable solvents are, for example, aliphatic or aromatic hydrocarbons such as pentane, hexane, heptane, toluene or xylene. The inertisation takes places at temperatures between 25° C. and 120° C., preferably between 50 and 70° C. Higher and lower temperatures are possible. The duration of the reaction is between 30 minutes and 20 hours, preferable 1 to 5 hours. On completion of the chemical dehydration process, the carrier material is isolated by filtration under inert conditions, washed once or several times with suitable inert solvents such as those already described above and subsequently dried in a stream of inert gas or under vacuum.

Organic carrier materials such as finely divided polyolefin powders (e.g. polyethylene, polypropylene or polystyrene) may also be used and should also be freed from adhering moisture, solvent residues or other impurities, before use, by corresponding cleaning and drying operations.

For the preparation of the carrier-supported system, at least one of the compounds of formula I described above is brought into contact, in a suitable solvent, with a least one co-catalyst component, a soluble reaction product, an adduct or an mixture preferably being obtained.

The preparation thus obtained is then mixed with the carrier material which is dehydrated or rendered inert, the solvent is removed and the resulting carrier-supported catalyst system is dried in order to ensure that the solvent is completely or largely removed from the pores of the carrier material. The carrier-supported catalyst is obtained as a free flowing powder.

A process for the preparation of a free-flowing and, if necessary, prepolymerised carrier-supported catalyst system comprises the following steps:

a) Preparation of a mixture of at least one compound of formula (I) and at least one co-catalyst in a suitable solvent or suspension agent

b) Applying the mixture obtained in step a) onto a porous, preferably inorganic dehydrated carrier

c) Removing the main part of the solvent from the resulting mixture

d) Isolating the carrier-supported catalyst system

e) If necessary, prepolymerisation of the carrier-supported catalyst system thus obtained with one or several olefinic monomer(s) in order to obtain a prepolymerised carrier-supported catalyst system.

Preferred solvents in step a) are hydrocarbons and hydrocarbon mixtures which are liquid at the reaction temperature selected and in which the individual components preferably dissolve. However, the solubility of the individual components is not a precondition, provided it is ensured that the reaction product of the compound of formula (I) and the co-catalyst is soluble in the solvent chosen. Examples of suitable solvents comprise alkanes such as pentane, isopentane, hexane, heptane, octane and nonane; cycloalkanes such as cyclopentane and cyclohexane; and aromatics such as benzene, toluene, ethylbenzene and diethylbenzene. Toluene is particularly preferred.

The quantities of aluminoxane and compound of formula (I) used for the preparation of the carrier-supported catalyst system may vary within a wide range. Preferably, a molar ratio of aluminium to transition metal of 10:1 to 1000:1, particularly preferably a ratio 50:1 to 500:1 is adjusted in the compound of formula I.

In the case of methylaluminoxane, 30% strength toluinic solutions are preferably used; however, using 10% solutions isalso possible.

For the preliminary activation, the compound of formula (I) is dissolved in the form of a solid in a solution of the aluminoxane in a suitable solvent. It is also possible to dissolve the compound of formula (I) separately in a suitable solvent and to combine this solution subsequently with the aluminoxane solution. Preferably, toluene is used.

The preliminary activation time is 1 minute to 200 hours. The preliminary activation may take place at room temperature (25° C.). Using higher temperatures may shorten the duration of the preliminary activation in individual cases and cause an additional increase in activity. In this case, higher temperatures means a region between 50 and 100° C.

The preactivated solution and/or the mixture is subsequently combined with an inert carrier material, usually silica gel, which is present in the form of a dry powder or as a suspension in one of the solvents mentioned above. Preferably, the carrier material is used as a powder. The sequence of addition is arbitrary. The preactivated non-metallocene-co-catalyst solution and/or the non-metallocene-co-catalyst mixture may be metered into the carrier material provided or the carrier material may be introduced into the solution provided.

The volume of the preactivated solution and/or the non-metallocene-co-catalyst mixture may exceed 100% of the total pore volume of the carrier material used or it may amount to up to 100% of the total pore volume.

The temperature at which the preactivated solution or the non-metallocene-co-catalyst mixture is brought into contact with the carrier material may vary within the region of 0 and 100° C. However, lower or higher temperatures are also possible.

Subsequently, the solvent is removed completely or largely from the carrier-supported catalyst system, the mixture being stirred and if necessary heated.

Preferably, both the visible portion of the solvent and the portion in the pores of the carrier material are removed. The removal of the solvent may take place in a conventional manner using vacuum and/or flushing with inert gas. During the drying process, the mixture may be heated until the free solvent has been removed; usually, this requires 1 to 3 hours at a temperature preferably chosen between 30 and 60° C. The free solvent is the visible portion of solvent in the mixture. Residual solvent should be understood to mean the portion which is enclosed in the pores. As an alternative to the complete removal of the solvent, the carrier-supported catalyst system may also be dried merely up to a certain residual solvent content, the free solvent being completely removed. Subsequently, the carrier-supported catalyst system is washed with a low boiling hydrocarbon such as pentane or hexane and dried once more.

The prepared carrier-supported catalyst system may be used either directly for the polymerisation of olefins or be prepolymerised before its use in a polymerisation process with one or several olefinic monomers. The execution of the prepolymerisation of carrier-supported catalyst systems is described in WO 94/28034, for example. As additive, it is possible to add, during or after the production of the carrier-supported catalyst system, a small quantity of an olefin, preferably an α-olefin, (e.g. vinylcyclohexane, styrene or phenyl dimethylvinylsilane) as modifying component or an antistatic agent (as described in U.S. Ser. No. 08/365,280). The molar ratio of additive to non-metallocene (compound of formula I) is preferably between 1:1000 and 1000:1, particularly preferably 1:20 to 20:1.

The catalyst systems prepared according to the process according to the invention are particularly suitable for the production of a polyolefin by the polymerisation of one or several olefins. The term polymerisation should be understood to mean homopolymerisation as well as copolymerisation.

Preferably, olefins with the formula Rₘ—CH═CH—Rₙ are polymerised, in which Rₘ and Rₙ are the same or different and represent a hydrogen atom or a carbon-containing radical with 1 to 20 C atoms, in particular 1 bis 10 C atoms, and Rₘ and Rₙ may form one or several rings together with the atoms linking them.

Examples of such olefins are 1-olefin with 2-20, preferably 2 to 10 C atoms such as ethene, propene, 1-butene, 1-pentene, 1-hexene, 4-methyl-1-pentene or 1-octene, styrene, dienes such as 1,3-butadiene, 1,4-hexadiene, vinylnorbornene, norbornadiene, ethylnorbornadiene and cyclic olefins such as norbornene, tetracyclododecene or methylnorbornene. In the process, propene or ethene are preferably homopolymerised or propene is copolymerised with ethene and/or with one or several 1-olefins with 4 to 20 C atoms such as butene, hexene, styrene or vinylcyclohexane and/or one or several dienes with 4 to 20 C atoms such as 1,4-butadiene, norbornadiene,.ethylidene norbonene or ethyinorbornadiene. Examples of such copolymers are ethene-propene copolymers or ethene-propene-1,4-hexadiene terpolymers.

The polymerisation is carried out at a temperature of 0 to 300° C., preferably 50 to 200° C., particularly preferably 50-80° C. The pressure is 0.5 to 2000 bar, preferably 5 to 64 bar.

The polymerisation may be carried out in solution, in bulk, in suspension or in the gaseous phase, continuously or batchwise, as a single or multiple stage. The prepared catalyst system may be used as the sole catalyst component for the polymerisation of olefins with 2 to 20 C atoms or preferably in combination with at least one alkyl compound from the elements of the main group I to III of the periodic system such as e.g. an aluminium, magnesium or lithium alkyl or an aluminoxane. The alkyl compound is added to the monomer or suspension agent and is used to purify the monomer of substances which might negatively affect the catalyst activity. The quantity of alkyl compound added depends on the quality of the monomers used.

If necessary, hydrogen is added as a molecular weight control and/or to increase the activity.

The catalyst system may be added to the polymerisation system in the pure state or, for better ease of metering, it may be mixed with inert components such as paraffins, oils or waxes. During the polymerisation, it is also possible to add an antistatic agent together with or separately from the catalyst system used to the polymerisation system in a controlled manner.

The invention is illustrated by the following examples which, however, do not restrict the invention.

General information: The manufacture and handling of the organometallic compounds takes place with the exclusion of air and moisture under argon blanketing (Schlenk technique or glove box). All the solvents required were flushed with argon before use and rendered absolute on molecular sieve.

1. Use of compounds of formula (I) 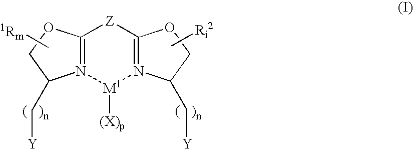
in which
M¹ is a metal from the group of the elements Ti, Zr, Hf, Ni, V, W, Mn, Rh, Ir, Cu, Co, Fe, Pd, Sc, Cr and Nb
R¹, R² respectively, are the same or different, represent a hydrogen atom or
Si(R¹²)₃, R¹² representing in the same way or differently a hydrogen atom or a C₁-C₄₀ carbon-containing group, in particular C₁-C₂₀ alkyl, C₁-C₁₀ fluoroalkyl, C₁-C₁₀ alkoxy, C₆-C₂₀ aryl, C₆-C₁₀ fluoroaryl, C₆-C₁₀ aryloxy, C₂-C₁₀ alkenyl, C₇-C₄₀ arylalkyl, C₇-C₄₀ alkylaryl or C₈-C₄₀ arylalkenyl,
or R¹, R², respectively, are the same or different, represent a C₁-C₃₀ carbon-containing group, in particular C₁-C₂₅ alkyl, particularly preferably methyl, ethyl, n-propyl, i-propyl, tert.-butyl, n-hexyl, cyclohexyl or octyl, C₂-C₂₅ alkenyl, C₃-C₁₅ alkylalkenyl, C₆-C₂₄ aryl, C₅-C₂₄ heteroaryl, C₇-C₃₀ arylalkyl, C₇-C₃₀ alkylaryl, fluorine-containing C₁-C₂₅ alkyl, fluorine-containing C₆-C₂₄ aryl, fluorine-containing C₇-C₃₀ arylalkyl, fluorine-containing C₇-C₃₀ alkylaryl or C₁-C₁₂ alkoxy,
or the radicals R¹ and R² can be linked with each other such that the radicals R¹ and R² respectively are bound to the oxazole ring such that the radicals R¹ and/or R² and the atoms linking them with the oxazole ring respectively form a C₄-C₂₄ ring system which in turn may be substituted,
n are the same or different and represent an integer between 1 and 3 and, if n represents the figure 0, at least one R¹, R² radical is not the same as hydrogen,
m is equal 0, 1, 2, 3 or 4,
i is equal 0, 1, 2, 3 or 4,
X can be the same or different and represent a hydrogen atom, a C₁-C₁₀ carbon-containing group, in particular C₁-C₁₀ alkyl or C₆-C₁₀ aryl, a halogen atom or OR⁹, SR⁹, OSi(R⁹)₃, Si(R⁹)₃, P(R⁹)₂ or N(R⁹)₂, in which R⁹ are a halogen atom, a C₁-C₁₀ alkyl group, a halogenated C₁-C₁₀ alkyl group, a C₆-C₂₀ aryl group or a halogenated C₆-C₂₀ aryl group or the X radical or radicals are a toluene sulphonyl group, a trifluoroacetyl, trifluoroacetoxyl, trifluoromethane sulphonyl, nonafluorobutane sulphonyl or 2,2,2-trifluoroethane sulphonyl group.
Y is equal OR¹⁰, SR¹⁰, OSi(R¹⁰)₃, Si(R¹⁰)₃, P(R¹⁰)₂ or N(R¹⁰)₂ in which the individual R¹⁰ may in the same way or differently represent a hydrogen atom, a halogen atom, a C₁-C₁₀ alkyl group, a halogenated C₁-C₁₀ alkyl group, a C₆-C₂₀ aryl group or a halogenated C₆-C₂₀ aryl group and Y may form a cyclic system with one or several R¹ and/or R² radicals,
p may be equal 1, 2, 3 or 4 and,
Z is a bridging structural element of formula M²R¹³R¹⁴, in which M² represents carbon, nitrogen, phosphorus, oxygen, sulphur, silicon, germanium, boron, aluminium or tin and R¹³ and R¹⁴ may be the same or different and represent a hydrogen atom, a C₁-C₂₄ hydrocarbon-containing group, in particular C₁-C₁₀ alkyl, particularly preferably methyl, ethyl, n-propyl-, i-propyl-, tert.-butyl, n-hexyl, cyclohexyl or octyl, C₂-C₁₀ alkenyl, C₃-C₁₀ alkylalkenyl, C₆-C₂₄ aryl, C₅-C₂₄ heteroaryl, C₇-C₂₄ arylalkyl, C₇-C₂₄ alkylaryl, fluorine-containing C₁-C₂₄ alkyl, fluorine-containing C₆-C₂₄ aryl, fluorine-containing C₇-C₂₄ arylalkyl, fluorine-containing C₇-C₂₄ alkylaryl or C₁-C₁₂ alkoxy or trimethylsilyl, in which the R¹³ and R¹⁴ radicals may be linked with each other in such a way that the R¹³ and R¹⁴ radicals form a C₄-C₂₄ ring system with the atoms linking them, which ring system in turn may be substituted, between the two oxazole rings, with the exception of the compounds [2,6-bis-(4S-isopropyl-2-oxaziln-2-yl)pyridine]MnCl2; [2,6-bis-(4S-isopropyl-2-oxaziln-2-yl)pyridine]CrCl2; [2,6-bis-(4S-isopropyl-2-oxaziln-2-yl)pyridine]FeCl2; [2,6-bis-(4S-isopropyl-2-oxaziln-2-yl)pyridine]FeCl3; [2,6-bis-(4S-isopropyl-2-oxaziln-2-yl)pyridine]VCl3; [2,6-bis-(4S-isopropyl-2-oxaziln-2-yl)pyridine]TiCl3 and [2,6-bis-(4S-isopropyl-2-oxaziln-2-yl)pyridine]ScCl3, for the polymerisation of olefins.

2. Use according to claim 1 characterised in that
R¹, R² respectively, are the same or different, represent a hydrogen atom or
Si(R¹²)₃, R¹² representing in the same way or differently a hydrogen atom, C₁-C₂₀ alkyl, C₁-C₁₀ fluoroalkyl, C₁-C₁₀ alkoxy, C₆-C₂₀ aryl, C₆-C₁₀ fluoroaryl, C₆-C₁₀ aryloxy, C₂-C₁₀ alkenyl, C₇-C₄₀ arylalkyl, C₇-C₄₀ alkylaryl or C₈-C₄₀ arylalkenyl, or R¹, R², respectively, represent in the same way or differently C₁-C₂₅ alkyl, particularly preferably methyl, ethyl, n-propyl, i-propyl, tert.-butyl, n-hexyl, cyclohexyl or octyl, C₂-C₂₅ alkenyl, C₃-C₁₅ alkylalkenyl, C₆-C₂₄ aryl, C₅-C₂₄ heteroaryl, C₇-C₃₀ arylalkyl, C₇-C₃₀ alkylaryl, fluorine-containing C₁-C₂₅ alkyl, fluorine-containing C₆-C₂₄ aryl, fluorine-containing C₇-C₃₀ arylalkyl, fluorine-containing C₇-C₃₀ alkylaryl or C₁-C₁₂ alkoxy,
or the radicals R¹ and R² can be linked with each other such that the radicals, R¹ and/or R² and the atoms linking them with the oxazole ring respectively form a C₄-C₂₄ ring system which in turn may be substituted.

3. Use of compounds of formula (II) 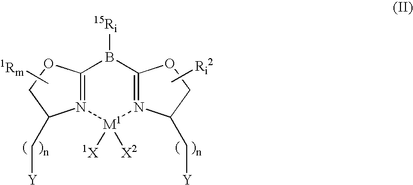
in which
M¹ is equal Ni, Pd, Co, Fe, Ti, Zr or Hf,
R¹, R², respectively, are the same or different, represent a hydrogen atom or
Si(R¹²)₃, R¹² representing in the same way or differently a hydrogen atom or a C₁-C₄₀ carbon-containing group, in particular C₁-C₂₀ alkyl, C₁-C₁₀ fluoroalkyl, C₁-C₁₀ alkoxy, C₆-C₂₀ aryl, C₆-C₁₀ fluoroaryl, C₆-C₁₀ aryloxy, C₂-C₁₀ alkenyl, C₇-C₄₀ arylalkyl, C₇-C₄₀ alkylaryl or C₈-C₄₀ arylalkenyl,
or R¹,R², respectively, are in the same way or different, represent C₁-C₃₀ carbon-containing group, in particular C₁-C₂₅ alkyl, particularly preferably methyl, ethyl, n-propyl, i-propyl, tert.-butyl, n-hexyl, cyclohexyl or octyl, C₂-C₂₅ alkenyl, C₃-C₁₅ alkylalkenyl, C₆-C₂₄ aryl, C₅-C₂₄ heteroaryl, C₇-C₃₀ arylalkyl, C₇-C₃₀ alkylaryl, fluorine-containing C₁-C₂₅ alkyl, fluorine-containing C₆-C₂₄ aryl, fluorine-containing C₇-C₃₀ arylalkyl, fluorine-containing C₇-C₃₀ alkylaryl or C₁-C₁₂ alkoxy, or the radicals R¹ and R² can be linked with each other such that the radicals R¹ and/or R² and the atoms linking them with the oxazole ring respectively form a C₄-C₂₄ ring system which in turn may be substituted,
n are the same or different and represent an integer between 1 and 3 and, if n represents the figure 0, at least one R¹, R² radical is not the same as hydrogen,
m is equal 0, 1, 2, 3 or 4,
i is equal 0, 1, 2, 3 or 4,
j is equal 1 or 2,
X¹, X² can be the same or different and represent a hydrogen atom, a C₁-C₁₀ carbon-containing group, in particular C₁-C₁₀ alkyl or C₆-C₁₀ aryl, a halogen atom or OR⁹, SR⁹, OSi(R⁹)₃, Si(R⁹)₃, P(R⁹)₂ or N(R⁹)₂, in which R⁹ are a halogen atom, a C₁-C₁₀ alkyl group, a halogenated C₁-C₁₀ alkyl group, a C₆-C₂₀ aryl group or a halogenated C₆-C₂₀ aryl group or the radicals X1, X2 are a toluene sulphonyl group, a trifluoroacetyl, trifluoroacetoxyl, trifluoromethane sulphonyl, nonafluorobutane sulphonyl or 2,2,2-trifluoroethane sulphonyl group.
R¹⁵ represents in the same way or differently a hydrogen atom, a C₁-C₂₄ hydrocarbon-containing group, in particular C₁-C₁₀ alkyl, particularly preferably methyl, ethyl, n-propyl-, i-propyl-, tert.-butyl, n-hexyl, cyclohexyl or octyl, C₂-C₁₀ alkenyl, C₃-C₁₀ alkylalkenyl, C₆-C₂₄ aryl, C₅-C₂₄ heteroaryl, C₇-C₂₄ arylalkyl, C₇-C₂₄ alkylaryl, fluorine-containing C₁-C₂₄ alkyl, fluorine-containing C₆-C₂₄ aryl, fluorine-containing C₇-C₂₄ arylalkyl, fluorine-containing C₇-C₂₄ alkylaryl or C₁-C₁₂ alkoxy or trimethylsilyl or several R¹⁵ can be linked to each other such that they form a C₄-C₂₄ ring system which in turn can be substituted,
B corresponds to the radical described for radical Z in formula (I),
Y is equal OR¹⁰, SR¹⁰, OSi(R¹⁰)₃, Si(R¹⁰)₃, P(R¹⁰)₂ or N(R¹⁰)₂ in which the individual R¹⁰ represents in the same way or differently a hydrogen atom, a halogen atom, a C₁-C₁₀ alkyl group, a halogenated C₁-C₁₀ alkyl group, a C₆-C₂₀ aryl group or a halogenated C₆-C₂₀ aryl group and Y may form a cyclic system with one or several R¹ and or R² radicals.

4. Catalyst system containing at least one compound of formula (I) defined in claim 1 and at least one co-catalyst.

5. Catalyst system according to claim 4 characterised in that the co-catalyst is at least one compound of the type of an aluminoxane or at least one Lewis acid or at least one ionic compound which converts the compound of formula (I) into a cationic compound.

6. Catalyst system according to claim 4 or 5 characterised in that it contains at least one carrier.

7. Use of a catalyst system according to claim 4 for the production of polyolefins by the polymerisation of one or several olefins.

8. Use according to claim 7 characterised in that it is a homopolymerisation or a copolymerisation of one or several olefins.

9. Process for the production of polyolefins in the presence of a catalyst system according to claim 4.
